(19) United States
(12) Patent Application Publication
(10) Pub. No.: US 2012/0239489 A1
(43) Pub. Date: Sep. 20, 2012

(54) METHOD AND SYSTEM FOR VIRAL PROMOTION OF ONLINE CONTENT

(75) Inventors: Jonah PERETTI, Brooklyn, NY (US); Ky Harlin, New York, NY (US)

(73) Assignee: Buzzfeed, Inc., New York, NY (US)

(21) Appl. No.: 13/422,710

(22) Filed: Mar. 16, 2012

Related U.S. Application Data
(60) Provisional application No. 61/453,831, filed on Mar. 17, 2011.

(51) Int. Cl. G06Q 30/02

(52) U.S. Cl. 705/14.45

(57) ABSTRACT

Methods and systems are provided for identifying online content that has a higher likelihood of being more effectively promoted (going viral). In one embodiment the invention includes monitoring traffic on an online network early in the life of a post (online publication of the content) to identify whether and/or which online content has a higher potential to be effectively promoted online. By checking the traffic characteristics against one or more thresholds at one or more time intervals early in the life of the post (e.g., within ten hours or less, or five hours or less), the online content with sufficient potential can be further promoted on various online outlets. For example, the promoting may include publishing a content online more frequently, publishing a content online more prominently, publishing a content on additional web pages, and/or modifying search engine results online to increase a ranking of the content.

### FIELD OF THE INVENTION

The present invention relates to the promotion of online content, and more particularly to a method and system for identifying online content that can be more effectively promoted.

### BACKGROUND

The Internet is a powerful tool for advertising and marketing products and services. It hosts websites and other types of interactive systems, e.g., blogs, message services, chat services, social networks, community sites, etc., on which consumers, advertisers, reviewers and others can post commentary, views and recommendations related to various types of products. An advertiser, which may be a company selling its product or an advertising agency hired by the company to sell its products, typically will pay a website owner or a search engine (a publisher) to advertise the product as a static or dynamic ad, banner ad, text ad, and the like. For example, when an Internet user performs a search, the results of the search may include display ads, and the Internet user can then click on a sponsored ad to navigate to the advertiser's website and obtain more information and/or buy the product.

Product reviews provided by consumers, such as bloggers, or on social networks, are also useful, both to the entity whose product is being reviewed, and also to prospective customers who may be interested in purchasing the product. In this way, the Internet is a powerful medium for word-of-mouth behavior from a wide variety of publishers, advertisers and consumers.

It would be highly desirable to provide tools that enable advertisers to more effectively determine whether and which of their online content is being most effectively viewed or shared on the Web. Due to the dynamic and distributed nature of the Web, it is very difficult to determine what content will reach the largest audience and/or lead to an increase in sales. Often such determinations are not made until an ad campaign has effectively ended and/or most of the advertising dollars have been spent. Prior techniques that rely upon predetermined target audience segments and presumed consumer interest, e.g., based on demographics, can be highly unreliable indicators.

Thus, there is a need for new tools that enable advertisers to more effectively determine what content can and should be promoted online.

### SUMMARY OF THE INVENTION

Methods and systems are provided for identifying online content that has a higher likelihood of being more effectively promoted (going viral). In one embodiment the invention includes monitoring traffic on an online network early in the life of a post (online publication of the content) to identify whether and/or which online content has a higher potential to be effectively promoted online. By checking the traffic characteristics against one or more thresholds at one or more time intervals early in the life of the post (e.g., within ten hours or less, or five hours or less), the online content with sufficient potential can be further promoted on various online outlets. For example, the promoting may include publishing a content online more frequently, publishing a content online more prominently, publishing a content on additional web pages, and/or modifying search engine results online to increase a ranking of the content.

In one example, traffic data is collected over a first time period, e.g., seven days, including two types of traffic data, internal or “paid-for views” of the online content that originate within a first network (e.g., the online advertising network in which impressions (views) are effectively paid-for by an advertiser), and outside traffic or “not-paid-for views” on a second network outside the first network in which referrers (referring web pages) generated through sharing on referring sites in a second network outside the first network generate traffic back to the original content page. By computing a ratio of the not-paid-for views to the paid-for views, for multiple individual URLs as well as various groupings of URLs, a model can be constructed from such data to identify which content is being most effectively shared. The traffic characteristics may be further classified to include various types of external traffic, including link traffic in which the domain of the referrer is different than the domain of the URL of the content and the referrer is not a search engine, search traffic in which the referrer is a search engine and a search term is identified, and direct traffic in which no referrer is available, e.g., from Twitter, email and instant messaging clients.

In one example, a viral potential is computed from a statistical model including a plurality of weighted factors, wherein a viral indicator ratio for the content, comprising a ratio of the not-paid-for views to the paid-for views, is one of the weighted factors. In another example, a second statistical model includes a plurality of weighted factors, one of the factors being the amount of not-paid-for views of the content. The step of determining whether the viral potential satisfies a minimum viral potential threshold may include determining whether the viral potential from the first statistical model satisfies a first minimum threshold and a viral potential computed from the second statistical model satisfies a second minimum threshold. In one example, where both thresholds are met, this event may trigger promotion of the identified content. In one example, the model comprises a multivariate linear regression model for predicting the viral potential.

In another embodiment, a method and system are provided for tracking the sharing of content online. In one example, a traffic code embedded on a landing page on which the content is published provides traffic information for determining the viral potential. In one example, an identifier is a appended to the content URL for distinguishing internal traffic (paid-for views) from external traffic (not-paid-for views).

These and other embodiments of the present invention will be further described below.

According to one embodiment of the invention, a method is provided for predicting a viral potential of online content published on a web page, the method comprising the steps of:
a. monitoring an online network in real-time after an initial publication of the content for an amount of paid-for views of the online content and an amount of not-paid-for views of the content;
b. computing a viral potential for the content based on a ratio of the not-paid-for views to the paid-for views;
c. determining whether the viral potential satisfies a minimum threshold for promoting the content online.

In accordance with another embodiment, the step of computing the viral potential is further based on one or more factors comprising:
a rate of change of the ratio;
an amount of not-paid-for views of the content referred from social media sites;
an amount of not-paid-for views of the content referred from search engines;
an amount of not-paid-for views of the content from referring sites;
an amount of not-paid for views of the content from direct visits;
an amount of not-paid-for views of the content from select queries of search engines;
an amount of not-paid-for views of the content referred from select search engines;
an amount of not-paid-for views of the content referred from select referrers;
a number of referring sites;
a change in any of the above factors;
a rate of change in any of the above factors; and
a size of the content's publisher.

In accordance with another embodiment, the step of computing the viral potential is further based on the amount of not-paid-for views of the content.

In accordance with another embodiment, the step of determining whether the viral potential satisfies a minimum threshold includes satisfying both a threshold for the not-paid-for views and a threshold for the ratio.

In accordance with another embodiment, the monitoring for an amount of not-paid-for views comprises tracking referrals of the online content wherein the domain of the referrer is different from the domain of the web page.

In accordance with another embodiment, the tracking includes tracking a unique identifier in the content which indicates a referral outside the domain of the web page.

In accordance with another embodiment, the tracking code determines for the detected view a referrer of the content.

In accordance with another embodiment, the method further comprises promoting the content by one or more of:
publishing the content online more frequently;
publishing the content online more prominently;
publishing the content on additional webpages;
modifying search engine results online to increase a ranking of the content.

In accordance with another embodiment, the step of computing the viral potential comprises:
computing from a first statistical model including a plurality of weighted factors, wherein the ratio comprises one of the factors.

In accordance with another embodiment, the step of computing the viral potential further comprises:
computing from a second statistical model including a plurality of weighted factors, wherein one of the factors is the amount of not-paid-for views of the content.

In accordance with another embodiment, the step of determining whether the viral potential satisfies a minimum threshold includes:
determining whether the viral potential computed from the first statistical model based on the ratio satisfies a first minimum threshold; and
determining whether the viral potential computed from the second statistical model based on the not-paid-for views satisfies a second minimum threshold.

In accordance with another embodiment, the first model comprises a multivariate linear regression model for computing the ratio.

In accordance with another embodiment, the second model comprises a multivariate linear regression model for computing the not-paid-for views.

In accordance with another embodiment, the monitoring step comprises sampling online network traffic at regular time intervals.

In accordance with another embodiment, the paid-for views are referred from inside the domain of an ad network and the not-paid-for views are referred from outside the domain of the ad network.

In accordance with another embodiment, the not-paid-for views comprise one or more of:
direct traffic where no referral is identified, link traffic referred from outside the domain of the content web page and the referrer is not a search engine, and search traffic referred from a search engine.

According to another embodiment, a computer program product is provided comprising program code which, when executed by a processor, performs the steps of the method.

According to another embodiment, a computer system including a server is provided having one or more processors and a memory storing one or more programs for execution by the one or more processors, for performing the method.

According to another embodiment of the invention, a computer implemented method is provided of promoting online content published on a web page, the method comprising:
computing in real time during an initial time period after publication of the online content a viral potential for the content, the viral potential being based on a ratio of an amount of not-paid-for views to an amount of paid-for views of the content;
determining if the viral potential meets a minimum threshold during the initial time period and if so, thereafter promoting the content on the online network.

According to another embodiment, the method further comprises:
for a plurality of online content published on the same or different web pages, performing the computing step for each content, and wherein the determining step comprises determining whether one or more of the viral potentials computed for the associated contents satisfies a minimum threshold and promoting the one or more contents that satisfy the threshold.

According to another embodiment of the invention, a computer-implemented method is provided for promoting online content, the method comprising the steps of:
a. publishing content on a web page of an online network;
b. monitoring, via a computer interface, the online network in real time after publication for an amount of paid-for views of the online content and an amount of not-paid-for views of the content;
c. computing, at a server, a viral potential for the content based on a ratio of the not-paid-for views to the paid-for views; and
d. determining whether the viral potential satisfies a minimum threshold and if so, promoting, via an online interface, the content on the network.

According to another embodiment of the invention, a computer-implemented method is provided comprising, at a server:
collecting traffic from online sources evidencing viewing of online content;
categorizing the traffic as:
   a paid-for view where a domain of a referrer of the online content is the same as a domain of a URL of the content;
   a not-paid-for view where a domain of a referrer of the online content is different than a domain of the URL of the content or no referrer is identified in the traffic;
computing an amount of not-paid-for views;
computing an amount of paid-for views;
computing a ratio of the not-paid-for views to the paid-for views;
determining whether both of the ratio and the amount of not-paid-for views satisfy respective thresholds.

In accordance with another embodiment, the method further comprises:
promoting the content for which the respective thresholds are satisfied on an online network.

### BRIEF DESCRIPTION OF THE FIGURES

FIG. 1 is a schematic block diagram of a system and method for identifying online content that can be effectively promoted according to one embodiment of the invention;

FIG. 2 is a flow chart illustrating one embodiment of a method for tracking the sharing of content online;

FIG. 3 is a flow chart illustrating one embodiment of a method for computing a viral potential;

FIG. 4 is a flow chart illustrating one embodiment of a method for constructing a model for identifying online content that can be effectively promoted;

FIG. 5 is a flow chart illustrating one embodiment of a method of executing a model to determine the viral potential of a published online content early in the life of the post of such content;

FIG. 6 is a schematic block diagram of a system and method for tracking paid-for and not-paid-for views of online content according to one embodiment of the invention;

FIG. 7 illustrates schematically three examples of online content publications that can be used to compare the relative effectiveness of the presentation and/or message of such content;

FIG. 8 is a schematic illustration of one example of building a statistical model;

FIG. 9 is a schematic illustration of one example of executing a statistical model to determine viral potential;

FIG. 10 is a block diagram illustrating an exemplary distributed computer system; and

FIG. 11 is a block diagram illustrating an exemplary computer server.

### DETAILED DESCRIPTION

Reference will be made to certain embodiments of the invention, examples of which are illustrated in the accompanying drawings. While the invention will be described in conjunction with the embodiments, it will be understood that this is not intended to limit the invention to these particular embodiments. On the contrary, the invention is intended to cover alternatives, modifications and equivalents that are within the scope of the invention as defined by the appended claims.

Moreover, in the description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the present invention.

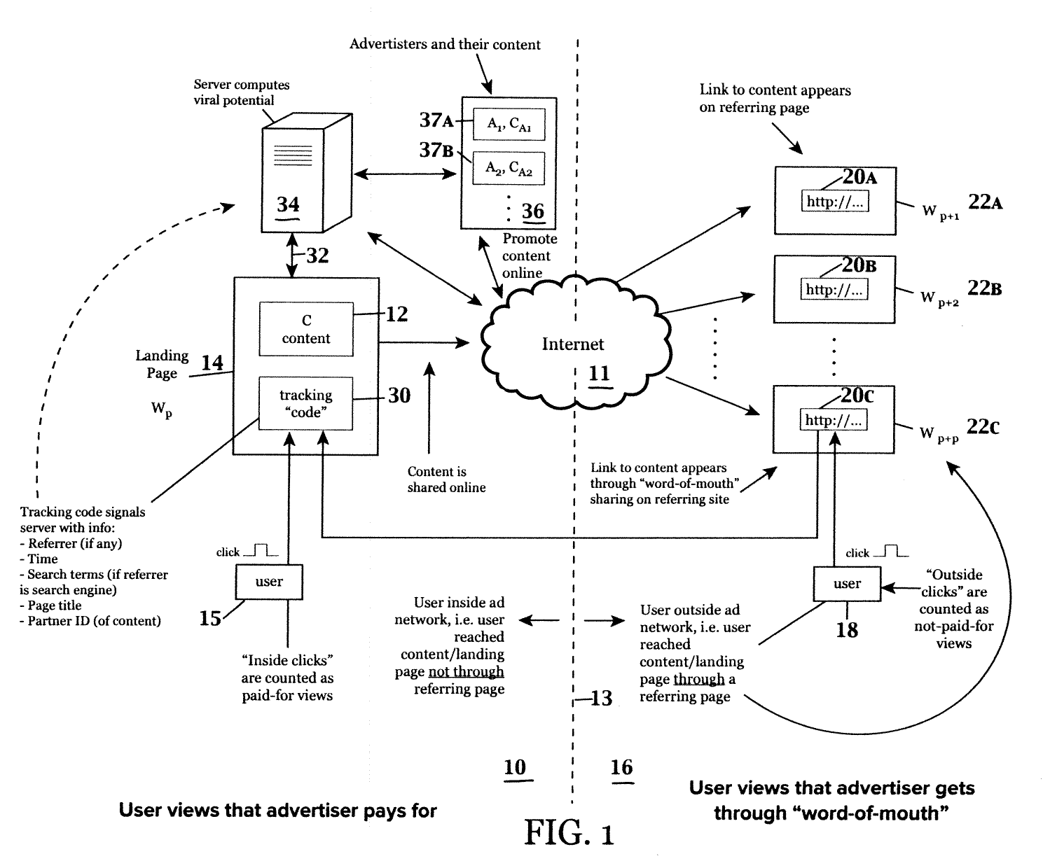

FIG. 1 is a schematic illustration of a method and system according to one embodiment of the invention. Online content (C) 12, such as an online ad, is published on a website, here shown as a landing page (Wp) 14 of an online ad network 10. A dashed line 13 down the center of FIG. 1 (and through Internet 11) schematically distinguishes Internet users 15 that view the content C on web page Wp from within the ad network 10, from Internet users 18 that reach the content/landing page though a referring page outside the ad network 10. The user views inside the ad network 10 are referred to as a “paid-for-view” in that such users view the content as a direct result of it being placed there by an advertiser or an agent of the advertiser. While most often that placement and the resulting views are literally paid for by the advertiser, it is not a requirement that there be an actual exchange of money.

The content 12 may be any type of online content or media. For example, such content may include text, graphics, audio or video, and is generally intended to convey a message, for an advertisement of a product, an article or editorial, a political message, and the like. The content may also include the website's domain, that is, the content can be considered to include the advertisement and the website that the advertisement is displayed on.

The content is then shared via the Internet 11, for example by way of social networks, whereby Internet users 18 on a second online network 16, outside the ad network 10, access links 20 to the content on other web pages 22 outside of the ad network. Such web pages are referred to as “referring pages” or “referrers”. Three such referring web pages 20a, 20b, 20c on three different websites 22a, 22b, 22c, respectively, are shown in FIG. 1. Upon clicking on those links, the user is taken to the landing page 14 where the content is displayed. Because the content is viewed by way of a referring page, the view is considered a “not-paid-for view” or an “outside click”.

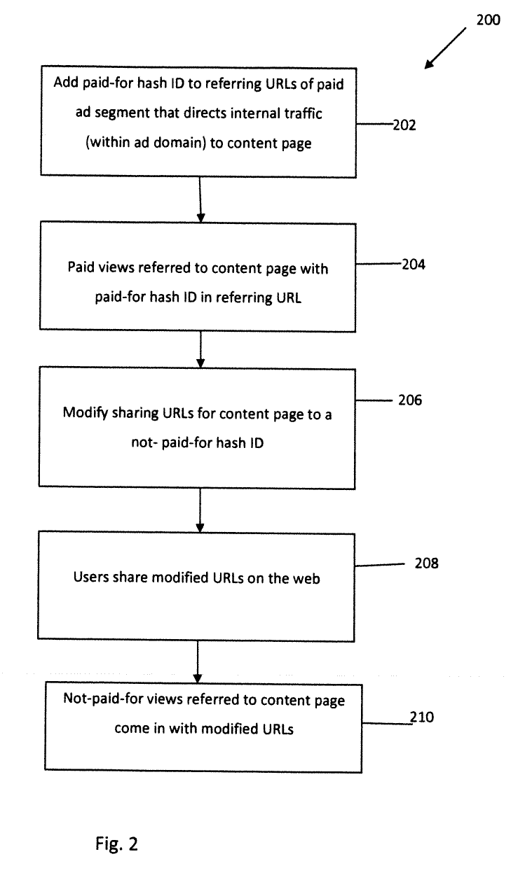

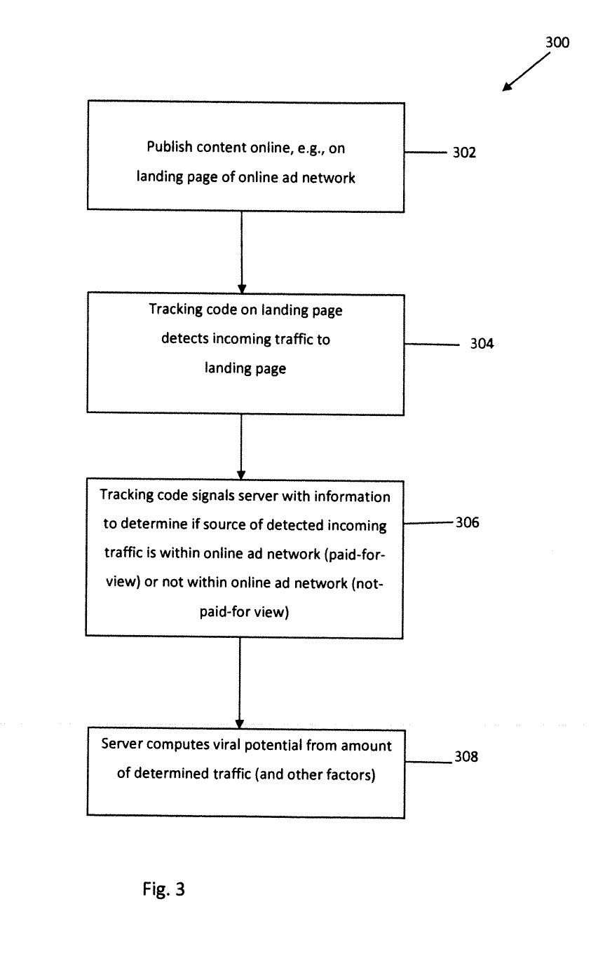

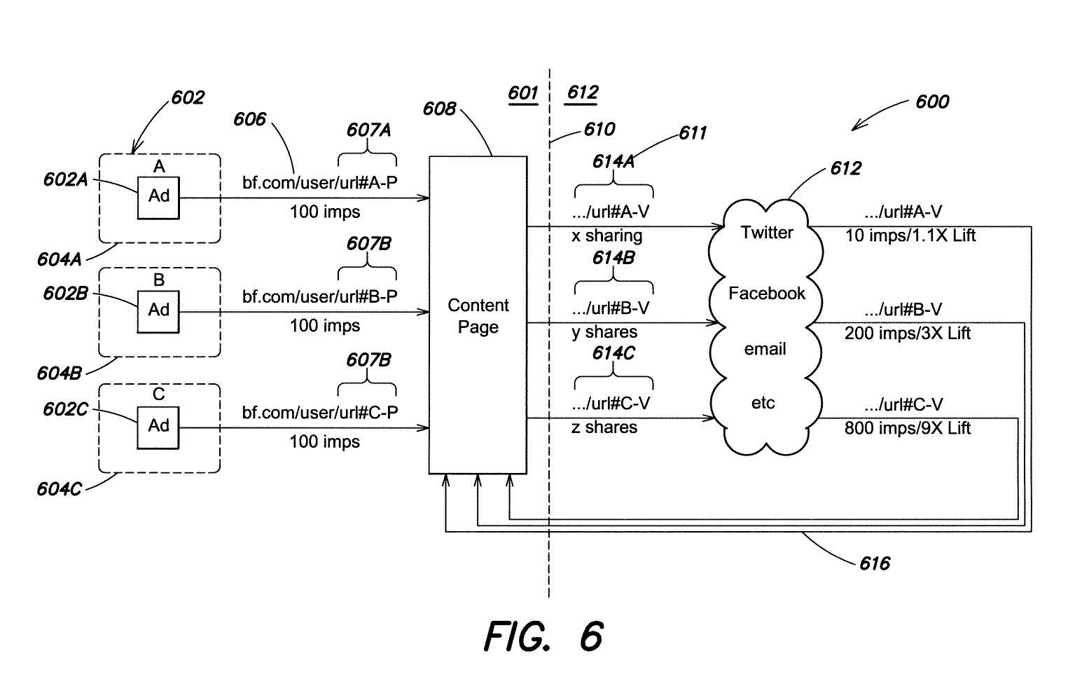

In one embodiment, tracking code is used to determine whether the view is a paid-for or not-paid-for view. The tracking code may utilize a unique identifier that persists when the content is transmitted or shared over the Internet. In one example, a hash identifier is appended to a content URL, as later described with respect to FIGS. 2 and 6. In one example, the tracking code may include code embedded on a web page, such as the tracking code 30 shown on the landing page 14 of FIG. 1. The following is one example of such tracking code (e.g., Java Script):

<div id = “BF_WIDGET_1”>&nbsp;</div>

<script type=“text/javascript”>

(function( ){

BF_WIDGET_JS=document.createElement(“script”);
BF-WIDGET_JS.type=”text/javascript”;
BF-WIDGET_SRC=”http://ct.buzzfeed.com/wd/UserWidget?

u= ‘+domain+’&amp;to=1&amp;or=vb&amp;wid=1&amp;cb= “+ (new Date
( )).getTime( );

setTimeout(function(

{dcoument.getElementByID(“BF_WIDGET_1”).appendChild(BF_WIDGET_JS);

BF_WIDGET_JS.src=BF_WIDGET_SRC},1);

})( );
</script>

Returning to FIG. 1, a server 34 communicates with landing page 14 and with a pool 36 of one or more advertisers and their associated content 37a, 37b, 37c, shown schematically as: A₁, C_{A1}; A₂, C_{A2}; . . . . The tracking code 30 embedded on the landing page 14 signals 32 the server 34 with traffic information that will enable a determination of one or more variables for determining which content can be most effectively promoted on the Web. For example, the information may include:
referrer (if any);
time;
search terms (if referrer is a search engine);
page title (of content);
partner ID (source of content, e.g., advertiser).

The server 34 can then use this information to compute a viral potential for the content, as described below. The viral potential can be compared to a minimum threshold for determining whether to promote the content on the networks 10 and/or 16. Generally, it is desirable to promote content having a higher ratio of not-paid-for views to paid-for views, and/or for a landing page having a higher ratio for not-paid-for views to paid-for views. Particular examples will be described in further detail below.

FIGS. 2-5 are flow charts representing various method embodiments of the invention. The process shown in each figure is performed by one or more processors or computer systems communicating on a network. More specific examples of such computer apparatus and program routines for implementing various embodiments of the invention are described below.

FIG. 2 illustrates one process 200 for distinguishing between paid-for views and not-paid-for views by the use of a tracking code with a hash ID. A more specific embodiment of this process is described below with regard to FIG. 6. In a first step 202, a paid-for hash ID is added to a referring URL of a paid ad segment for directing internal traffic (within the ad domain) to the content page. In a next step 204, when users are referred by the ad segment to the content page (a paid referral), these paid-for views are identified by the paid-for hash ID. In contrast, the sharing URL's for the content page are modified to include a not-paid-for hash ID. Users then share the modified URL's on the Web, as the content is spread among users (step 208). These not-paid-for (or viral) views referred to the content page, are received by the content page with the modified (not-paid-for) URL's. This is one method for distinguishing paid-for and not-paid-for views of the content page.

FIG. 3 illustrates another process 300 embodiment of the invention for computing the viral potential based upon incoming traffic to the content page. In a first step 302, the content is published, e.g., on the landing page of an online ad network. Next (step 304), tracking code on the landing page detects incoming traffic to the landing page. Next (step 306), the tracking code signals a server with this information to determine if the source of the detected incoming traffic is within the online ad network (a paid-for view) or not within the online network (a not-paid-for view). The server computes the viral potential from the amount of determined traffic; the computation may include other factors (step 308).

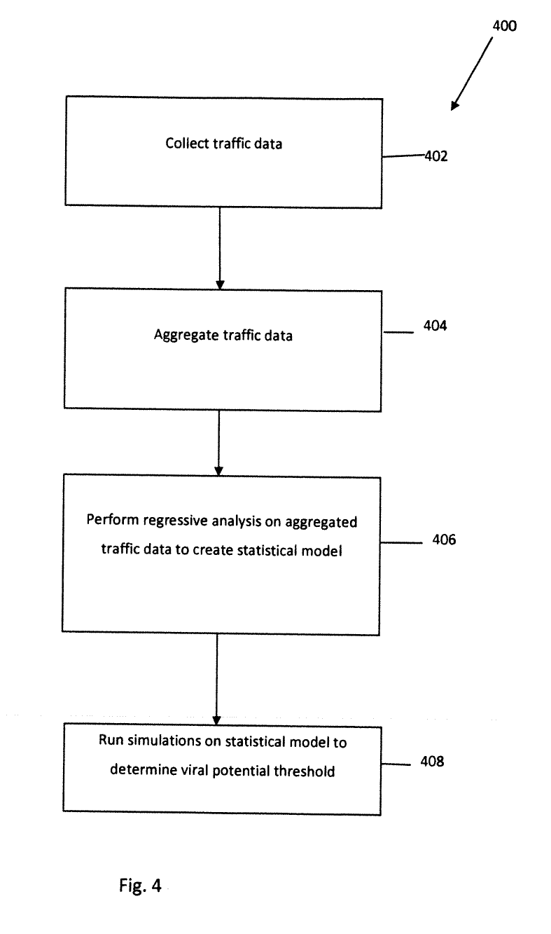

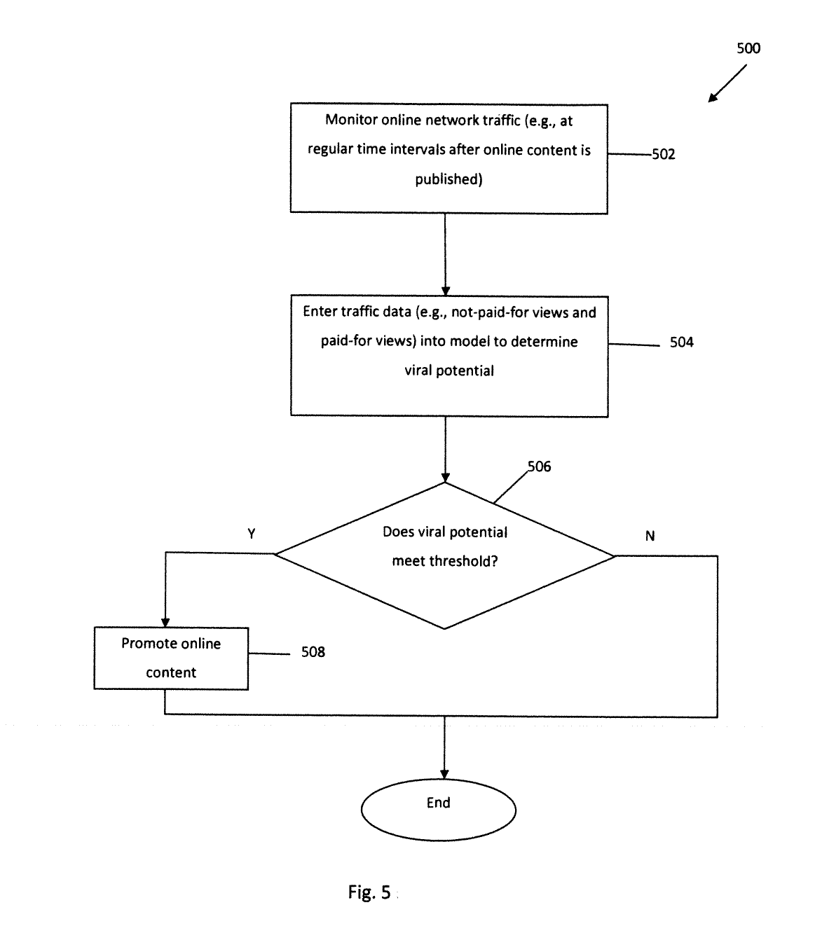

FIG. 4 illustrates one method 400 embodiment for building a statistical model for determining viral potential. In a first step (step 402), traffic data is collected from an online network for the online content. In a next step 404, the traffic data is aggregated, e.g., with respect to time (hourly, daily, etc.) and/or with respect to other factors (source, referrer, etc.). Next (step 406), a regressive analysis is performed on the aggregated traffic to create a statistical model. Then, simulations are run on the statistical model to determine a viral potential threshold (step 408).

FIG. 5 illustrates a further process 500 embodiment of the invention for determining which online content to promote. In a first step 502, the online network traffic is monitored, e.g., at regular time intervals after the online content is published. Next (step 504), the traffic data from the monitoring step (e.g., not-paid-for views and paid-for views) is entered into the model to determine a viral potential. Next (step 506), a comparison is made to determine whether the viral potential meets a minimum threshold. If it does, then the online content will be promoted (step 506). If not, the process ends.

FIG. 6 is a more specific, schematic illustration of one method of distinguishing paid-for views and not-paid-for views. Starting on the left, a plurality of paid-for ad segments A, B and C (602a, 602b, 602c) are posted one each on a different website (604a, 604b, 604c respectively) for directing internal traffic on an ad network 601 to a content page 608. Here, the content page is on a different website than websites 604. Each ad segment 602a, 602b, 602c is provided with a different identifying hash ID 606. Here the paid-for ad segment URLs have the form “bf.com/user/hash ID”, where the hash ID “uri#A-P”, “uri# B-P”, and “uri#C-P” respectively identify the ad segment (A, B, or C) as a paid-for view (-P). More specifically, each ad 602 contains a hyperlink to URL 606, so users are directed to URL 606 by clicking on ad 602. Such clicks are recorded by the tracking code which categories the click as a paid-for view. Following this, users are automatically redirected to a sharing URL 611, containing content page 608 as described below. Thus, if these same users share the content 608 on social network 612, they are using the sharing URL 611, not URL 606. If other users click the sharing URL 611 on social network 612 the tracking code characterizes the click as a not-paid-for view and the content page 608 is shown. No redirection occurs in this case. Also users accessing the content page directly (within the website on which the content page is located), do not get any hash ID, but may also be considered a paid-for view.

Thus, when the content page is shared by users on a second network 612, i.e., outside ad network 601, the sharing URL's 611 include a not-paid-for hash ID 614, e.g, . . . /uri#A-V (the P is replaced by a V in the original URL). Users share these modified URL's on the second network 612 (e.g., via Twitter, Facebook, email, etc), and the modified URLs are spread on the Web. As a result of such sharing, any referred views 616 that come in with the not-paid-for hash 614 are identified as a not-paid-for view.

In this example the three ad segments labeled A, B and C, each having a different hash ID and all referring to the same content page 608, can be used to track which segment is more effective in referring traffic to the content page. Thus, the paid-for 606 and not-paid-for 611 URL's both include the segment designation A, B or C, enabling the advertiser to determine, based upon the amount of views for the respective segments, which segment is more effective in generating referrals. Then, this particular segment can be preferentially used for future promotions of the content.

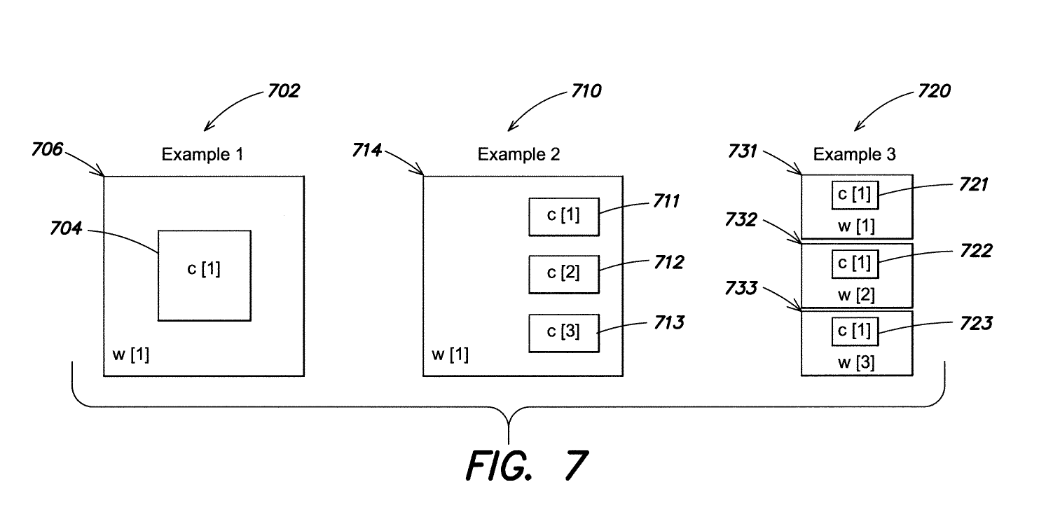

FIG. 7 is another example that illustrates “how” content is published can be used to determine what is more effective (shared more). In example 1 (702), an advertiser has placed content c[1] 704 on a website w[1] 706, e.g., Ford has an advertisement for a new car published on its own website. By monitoring traffic to this content on web page w[1], and determining a viral potential from such traffic over a defined time period after publication, the advertiser can determine how effective this content and/or web page may be.

In a second example 710, an advertiser has three different contents 711-713, C[1], C[2] and C[3], all published on a single web page w[1] 714. For example, The Huffington Post may have three stories (three different contents) that are published on one web page on The Huffington Post site. By monitoring the traffic to the respective contents 711, 712, 713, the advertiser can determine which content will be most popular. The difference in content may be either a difference in the content itself, or in its location on the page.

In a third example 720, an advertiser has one content c[1], but here the advertiser publishes the same content on each of three different web pages 731-733. For example, an advertiser may have branded content that is shown on three different websites, such as College Humor, Funny or Die, and Cracked.com. By comparing the traffic referred to the same content 721-723 on each of the respective web pages 731-733, the advertiser can determine how such content can be more effectively promoted.

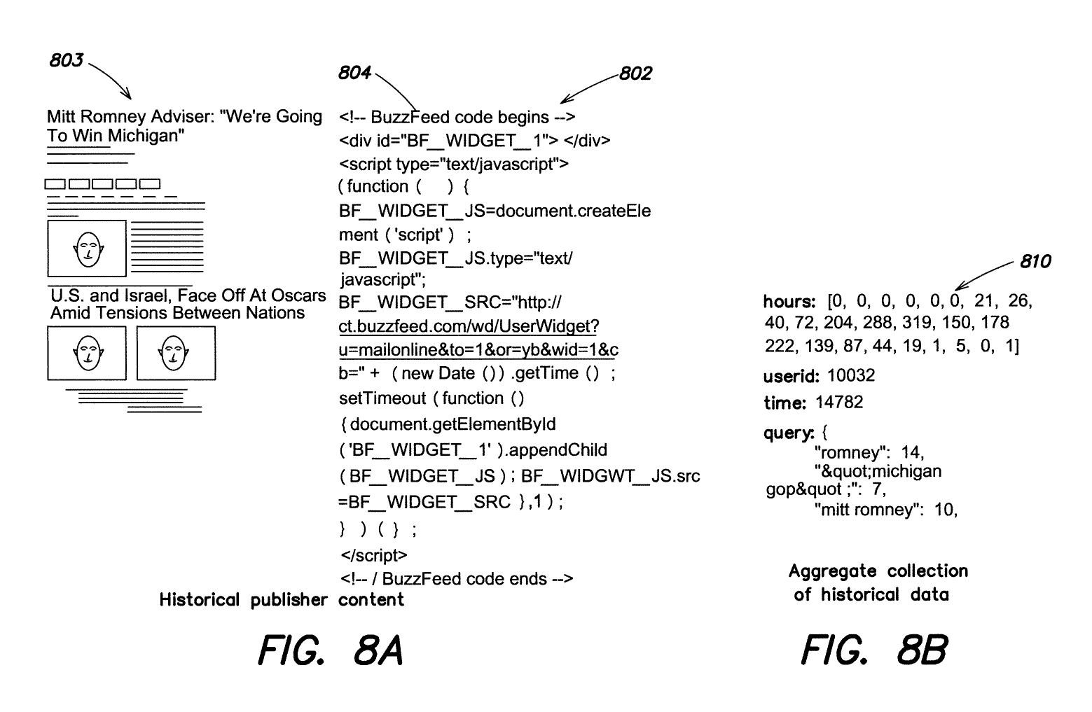

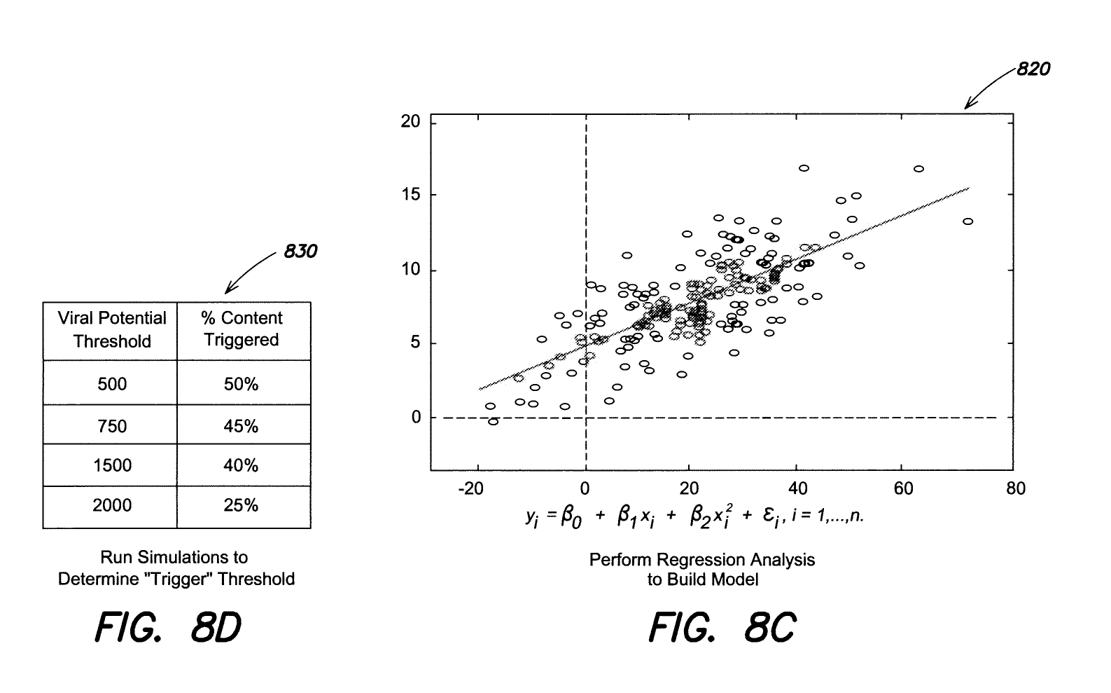

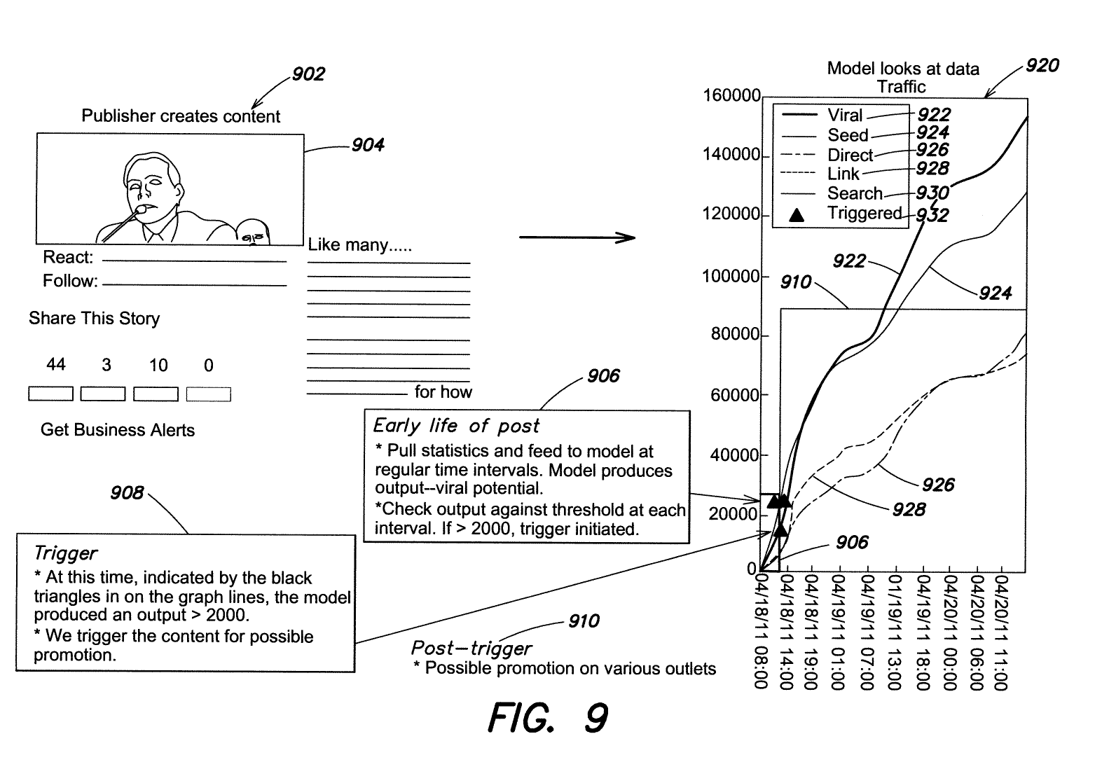

FIGS. 8-9 illustrate more specific examples of a method of building a statistical model (FIG. 8), and then executing that model following online publication of specific content to determine the viral potential for that content (FIG. 9).

FIG. 8A shows as a first step 802 one example of a web page 803 having embedded tracking code 804 for tracking referrals. In one example, daily and hourly traffic totals for each of a plurality of content URLs and traffic types is collected. Internal traffic is a referral where the referrer is in the same domain as the content URL. External traffic includes:
direct traffic, where no referral is available, (e.g., Twitter, email or instant messaging);
link traffic where the referrer is in a different domain than the content URL and is not a search engine; and
search traffic where the referrer is a search engine and a search term is identified.

In a next step 810, shown in FIG. 8B, times-series data (collected by monitoring the online network) is aggregated (e.g., a week's worth of data), and in a next step 820 a regression analysis is performed on the aggregated data to built a model. FIG. 8C illustrates one example of a linear regression model built from the historical data. In a next step 830 shown in FIG. 8D, the model can then be used to run simulations to determine an appropriate threshold for determining which content to promote. In this example, it is determined that 25% of a publisher's content is a desired minimum, and the corresponding viral potential threshold is set at 2000.

Multivariate linear regression analysis can be used to describe a relationship between a dependent variable and several independent variables. In one example, the dependent variable is the ratio of the not-paid-for views to the paid-for views at some future time (e.g., several hours) after the content URL is posted, and the independent variables are traffic statistics at some initial time period (e.g., within one hour) after the URL is posted. The several independent variables are given respective relative weights in the regression model. The independent variables may include, in addition to the viral indicator ratio:
a rate of change of the viral indicator ratio;
an amount of not-paid-for views of the content referred from social media sites;
an amount of not-paid-for views of the content referred from search engines;
an amount of not-paid-for views of the content from referring sites;
an amount of not-paid for views of the content from direct visits;
an amount of not-paid-for views of the content from select queries of search engines;
an amount of not-paid-for views of the content referred from select search engines;
an amount of not-paid-for views of the content referred from select referrers;
a number of referring sites;
a change in any of the above factors;
a rate of change in any of the above factors; and
a size of the content's publisher.

The model may be represented in a generalized form as a summation of weighted factors as shown below:

yᵢ=β₀+β₁xᵢ+β₂xᵢ²+cᵢ, i=1, . . . , n.

where yᵢ is the dependent variable, xᵢ is the independent variable, beta is the weight of the respective variable and epsilon is an error term which may capture other factors which influence the dependent variable yᵢ other than the independent variables xᵢ. In one embodiment, two multivariate linear regression models with the independent variables described above are built, one is used to predict viral traffic (not-paid-for views) and the other to predict the viral ratio (the ratio of not-paid-for views to paid-for views). Each model may be built using sample data from traffic logs over an extended time period e.g., multiple months, or even years. A generalized linear model including polynomial regression may be used depending upon the observed relationship between the dependent and independent variables in the historical data. As time-series data is used the generalized difference equation and Durbin-Watson statistic address concerns of autocorrelation may be used. These examples are not intended to be limiting but only illustrate one embodiment of the invention.

FIG. 9 illustrates one example of executing a model (e.g., the model of FIG. 8) to compute a viral potential. In a first step 902, a publisher posts a specific content 904 online. Early in the life of that posting 906, online traffic is monitored to pull various statistics and feed them to the model at regular time intervals. The model produces an output, a viral potential. The output (viral potential) is checked against a threshold at each interval 908. If a minimum threshold (e.g., 2000) is met, the content is identified for possible future promotion 910. FIG. 9 shows a graph 920 for plotting monitored traffic data (e.g., views) on the y-axis against time on the x-axis. The traffic statistics illustrated in FIG. 9 include: not-paid-for views 922, paid-for views 924, direct traffic 926, link traffic 928, and search traffic 930, as previously described. In this example, two statistical models are used, one to predict the ratio and another to predict the amount of not-paid-for views. Here, thresholds 932 are met for each of these models at the time denoted by the two triangles early in the post. In this example, when both thresholds are met the viral potential threshold is met, and the content is selected for future online promotion.

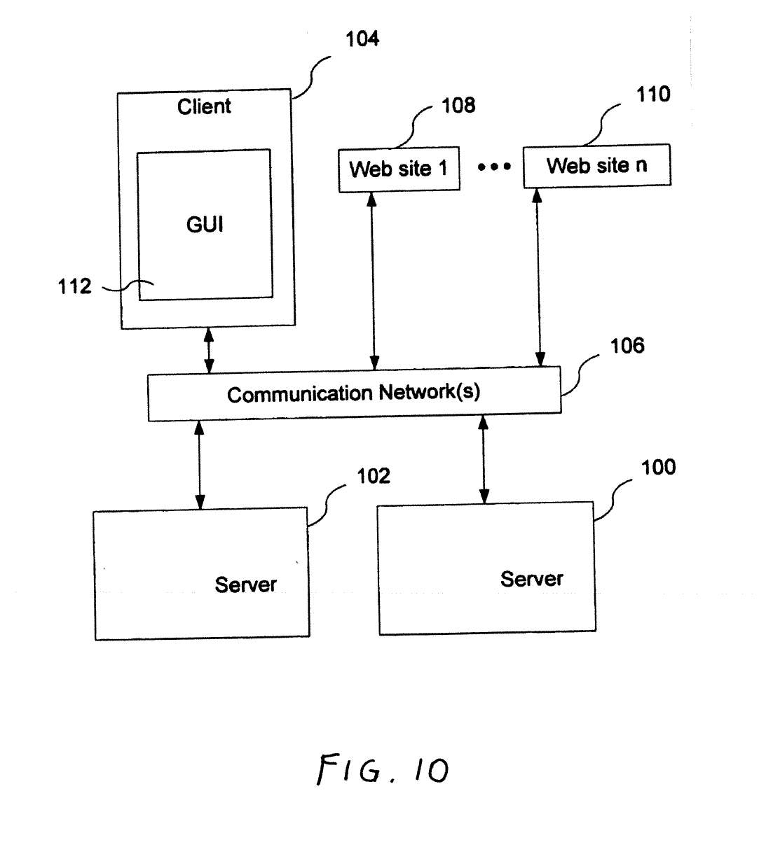

FIG. 10 is a block diagram illustrating an exemplary distributed computer system that may be used in one embodiment of the invention. This system includes one or more client computer(s) 104, servers 100, 102, multiple web sites 108 and 110, and communication network(s) 106 for interconnecting these components. Client 104 includes graphical user interface (GUI) 112. Server 102 collects traffic data from multiple web sites 108-110, identifies particular content, generates aggregated traffic information for particular content, computes the viral indicator ratio and viral potential and stores the content, aggregated traffic information and/or computed values. Server 102 may also receive and respond to requests from client 104, e.g., to provide a viral potential for a content and/or to search within traffic for a particular content, and may publish and/or promote content online. GUI 112 may display a plurality of content, traffic and/or computed values and may include a search input area for entering search terms to search for traffic or content that contain the search terms.

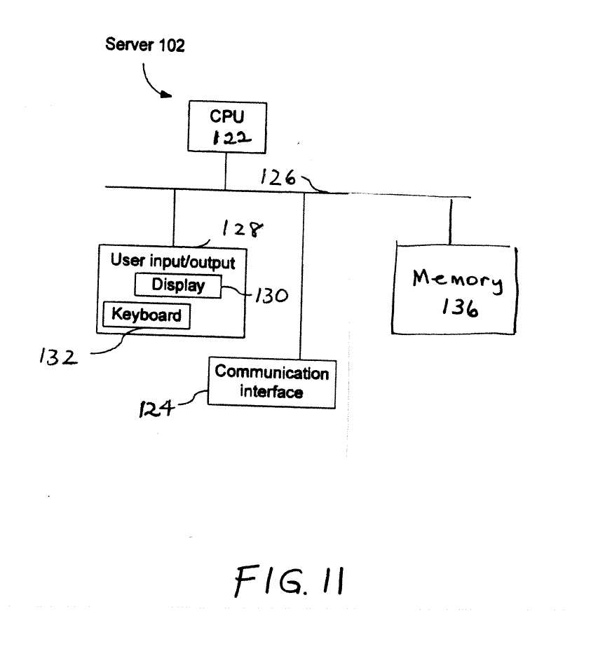

FIG. 11 is a block diagram illustrating a server 102 that can be used in one embodiment of the present invention. Server 102 typically includes one or more processing units (CPU's) 122, one or more online network or other communication interfaces 124, memory 136, and one or more communication buses 126 for interconnecting these components. Server 102 optionally may include a user interface 128 comprising a display device 130 and a keyboard 132. Memory 136 may include high speed random access memory and may also include non-volatile memory, such as one or more magnetic disk storage devices. Memory 136 may optionally include one or more storage devices remotely located from the CPU(s) 122. In some embodiments, the memory stores programs, modules and data structures, and subsets thereof.

It is to be understood that the foregoing description is intended to illustrate and not to limit the scope of the invention.

1. A computer-implemented method for predicting a viral potential of online content published on a web page, the method comprising the steps of:
a. monitoring, via a processor, an online network in real-time after an initial publication of the content for an amount of paid-for views of the online content and an amount of not-paid-for views of the content;
b. computing, via a processor, a viral potential for the content based on a ratio of the not-paid-for views to the paid-for views;
c. determining, via a processor, whether the viral potential satisfies a minimum threshold for promoting the content online.

2. The method of claim 1, wherein the step of computing the viral potential is further based on one or more factors comprising:
a rate of change of the ratio;
an amount of not-paid-for views of the content referred from social media sites;
an amount of not-paid-for views of the content referred from search engines;
an amount of not-paid-for views of the content from referring sites;
an amount of not-paid for views of the content from direct visits;
an amount of not-paid-for views of the content from select queries of search engines;
an amount of not-paid-for views of the content referred from select search engines;
an amount of not-paid-for views of the content referred from select referrers;
a number of referring sites;
a change in any of the above factors;
a rate of change in any of the above factors; and
a size of the content's publisher.

3. The method of claim 1, wherein the step of computing the viral potential is further based on the amount of not-paid-for views of the content.

4. The method of claim 3, wherein the step of determining whether the viral potential satisfies a minimum threshold includes satisfying both a threshold for the not-paid-for views and a threshold for the ratio.

5. The method of claim 1, wherein the monitoring for an amount of not-paid-for views comprises tracking referrals of the online content wherein the domain of the referrer is different from the domain of the web page.

6. The method of claim 5, wherein the tracking includes tracking a unique identifier in the content which indicates a referral outside the domain of the web page.

7. The method of claim 6, wherein the tracking code determines for the detected view a referrer of the content.

8. The method of claim 1, further comprising promoting the content by one or more of:
publishing the content online more frequently;
publishing the content online more prominently;
publishing the content on additional webpages;
modifying search engine results online to increase a ranking of the content.

9. The method of claim 1, wherein the step of computing the viral potential comprises:
computing from a first statistical model including a plurality of weighted factors, wherein the ratio comprises one of the factors.

10. The method of claim 9, wherein the step of computing the viral potential further comprises:
computing from a second statistical model including a plurality of weighted factors, wherein one of the factors is the amount of not-paid-for views of the content.

11. The method of claim 10, wherein the step of determining whether the viral potential satisfies a minimum threshold includes:
determining whether the viral potential computed from the first statistical model based on the ratio satisfies a first minimum threshold; and
determining whether the viral potential computed from the second statistical model based on the not-paid-for views satisfies a second minimum threshold.

12. The method of claim 9, wherein the first model comprises a multivariate linear regression model for computing the ratio.

13. The method of claim 10, wherein the second model comprises a multivariate linear regression model for computing the not-paid-for views.

14. The method of claim 1, wherein the monitoring step comprises sampling online network traffic at regular time intervals.

15. The method of claim 1, wherein the paid-for views are referred from inside the domain of an ad network and the not-paid-for views are referred from outside the domain of the ad network.

16. The method of claim 1, wherein the not-paid-for views comprise one or more of:
direct traffic where no referral is identified, link traffic referred from outside the domain of the content web page and the referrer is not a search engine, and search traffic referred from a search engine.

17. A computer program product comprising program code which, when executed by a processor, performs the steps of method claim 1.

18. A computer system including a server having one or more processors and a memory storing one or more programs for execution by the one or more processors, for performing the method of claim 1.

19. A computer-implemented method of promoting online content published on a web page, the method comprising:
computing, via a processor, in real time during an initial time period after publication of the online content a viral potential for the content, the viral potential being based on a ratio of an amount of not-paid-for views to an amount of paid-for views of the content;
determining, via a processor, if the viral potential meets a minimum threshold during the initial time period and if so, thereafter promoting the content on the online network.

20. The method of claim 19, further comprising:
for a plurality of online content published on the same or different web pages, performing the computing step for each content, and wherein the determining step comprises determining whether one or more of the viral potentials computed for the associated contents satisfies a minimum threshold and promoting the one or more contents that satisfy the threshold.

21. A computer-implemented method for promoting online content, the method comprising the steps of:
a. publishing content on a web page of an online network;
b. monitoring, via a computer interface, the online network in real time after publication for an amount of paid-for views of the online content and an amount of not-paid-for views of the content;
c. computing, at a server, a viral potential for the content based on a ratio of the not-paid-for views to the paid-for views; and
d. determining whether the viral potential satisfies a minimum threshold and if so, promoting, via an online interface, the content on the network.

22. A computer-implemented method comprising, at a server:
collecting traffic from online sources evidencing viewing of online content;
categorizing the traffic as:
a paid-for view where a domain of a referrer of the online content is the same as a domain of a URL of the content;
a not-paid-for view where a domain of a referrer of the online content is different than
a domain of the URL of the content or no referrer is identified in the traffic;
computing an amount of not-paid-for views;
computing an amount of paid-for views;
computing a ratio of the not-paid-for views to the paid-for views;
determining whether both of the ratio and the amount of not-paid-for views satisfy respective thresholds.

23. The method of claim 22, further comprising:
promoting the content for which the respective thresholds are satisfied on an online network.
